(19) United States
(12) Patent Application Publication
(10) Pub. No.: US 2022/0059281 A1
(43) Pub. Date: Feb. 24, 2022

(54) COIL COMPONENT

(71) Applicant: TDK CORPORATION, TOKYO (JP)

(72) Inventors: Terumasa TOYODA, TOKYO (JP); Hiroshi SUZUKI, TOKYO (JP); Toru TONOGAI, TOKYO (JP); Keigo HIGASHIDA, TOKYO (JP); Hanako YOSHINO, TOKYO (JP)

(73) Assignee: TDK CORPORATION, TOKYO (JP)

(21) Appl. No.: 17/399,855

(22) Filed: Aug. 11, 2021

(30) Foreign Application Priority Data
Aug. 19, 2020 (JP) 2020-138352

(51) Int. Cl. H01F 27/29; H01F 17/04; H01F 27/28

(52) U.S. Cl. CPC H01F 27/292; H01F 2017/048; H01F 27/2823; H01F 17/045

(57) ABSTRACT

Disclosed herein is a coil component that includes a plate-like base member, a magnetic core mounted on the base member, a wire wound around the magnetic core such that an axis direction thereof is substantially parallel to the base member, and a terminal electrode fixed to the base member and connected to an end portion of the wire. The base member is made of a material having a permeability lower than that of the magnetic core.

### BACKGROUND OF THE INVENTION

### Field of the Invention

The present invention relates to a coil component and, more particularly, to a coil component having a structure in which a wire is wound around a magnetic core made of ferrite or the like.

### Description of Related Art

JP 2007-095949A and JP 2013-187319A disclose a coil component having a structure in which a coil body combining an air-core coil and a magnetic core is mounted on a base member. However, in the coil component described in JP 2007-095949A and JP 2013-187319A, the use of the air-core coil complicates the manufacturing process. Further, the coil axis is perpendicular to the base member, so that a large amount of magnetic flux is applied to a terminal electrode and its corresponding land pattern formed on a substrate, which may easily cause an eddy current.

To solve such a problem, the coil axis is set parallel to the substrate by using a drum-shaped magnetic core as described in JP 2018-010990A. In the coil component described in JP 2018-010990A, a terminal electrode is provided on each of a pair of flange parts of the drum-shaped magnetic core.

However, in the coil component described in JP 2018-010990A, the terminal electrode is directly formed on the magnetic core, so that the amount of magnetic flux to be applied to the terminal electrode and its corresponding land pattern cannot be reduced to a sufficient level.

### SUMMARY

It is therefore an object of the present invention to, in a coil component whose axial direction is set parallel to a substrate, reduce an eddy current generated in a terminal electrode and its corresponding land pattern formed on the substrate.

A coil component according to the present invention includes: a plate-like base member; a magnetic core mounted on the base member; a wire wound around the magnetic core such that the axis direction thereof is substantially parallel to the base member; and a terminal electrode fixed to the base member and connected to the end portion of the wire. The base member is made of a material having a permeability lower than that of the magnetic core.

According to the present invention, the wire is wound around the magnetic core such that the axis direction thereof is horizontal, and the terminal electrode is fixed to the base member having a low permeability, so that the amount of magnetic flux to be applied to the terminal electrode is reduced. This reduces an eddy current generated in the terminal electrode and a land pattern formed on a substrate, making it possible to reduce heat generation of the terminal electrode and land pattern.

In the present invention, a through hole may be formed in the base member, and the end portion of the wire may be connected to the terminal electrode through the through hole. This eliminates or reduces the exposed area of the wire, increasing reliability.

In the present invention, the magnetic core may have a U-like shape having a winding core part around which the wire is wound and first and second leg parts provided at axially opposite ends of the winding core part and protruding facing away from the base member. This reduces the height dimension as compared to when a drum-shaped magnetic core is used. In this case, the coil component may further have a plate-like core fixed to the first and second leg parts and having a permeability higher than that of the base member. This can further increase inductance.

The coil component according to the present invention may further have a molding member formed on the base member so as to cover the magnetic core. Since the magnetic core and wire are covered with the molding member, reliability can be increased. In this case, the molding member may be made of a material having a permeability higher than that of the base member. This can reduce magnetic flux leaked to the outside and can further increase inductance.

In the present invention, a plurality of magnetic cores may be mounted on the base member. This allows the coil component to be used as a so-called array product, thus reducing the number of components.

The coil component according to the present invention may further include an electronic component mounted on the base member, and the end portion of the wire and the terminal electrode may be connected through the electronic component. This allows the coil component to be used as a more sophisticated module component, thus reducing the number of components.

As described above, according to the present invention, in a coil component whose axial direction is set parallel to a substrate, it is possible to reduce an eddy current generated in a terminal electrode and its corresponding land pattern formed on the substrate.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a schematic transparent perspective view illustrating the outer appearance of a coil component 1 according to a first embodiment of the present invention;

FIG. 2 is a schematic transparent perspective view of the coil component 1 as viewed in a different angle from the angle of FIG. 1;

FIG. 3 is a schematic diagram for explaining a method for mounting the coil component 1 on a substrate 40;

FIGS. 4 and 5 are diagrams for explaining a manufacturing process of the coil component 1;

FIG. 6 is a schematic transparent perspective view illustrating the outer appearance of a coil component 2 according to a second embodiment of the present invention;

FIG. 7 is a schematic transparent perspective view illustrating the outer appearance of a coil component 3 according to a third embodiment of the present invention;

FIG. 8 is a view illustrating a state where the magnetic core 10, plate-like core 14, and wires W1 and W2 are removed from the coil component 3;

FIG. 9 is a view illustrating the structure of the base member 21 used by the coil component 3; and

FIG. 10 is an equivalent circuit diagram of the coil component 3.

### DETAILED DESCRIPTION OF THE EMBODIMENTS

Preferred embodiments of the present invention will be explained below in detail with reference to the accompanying drawings.

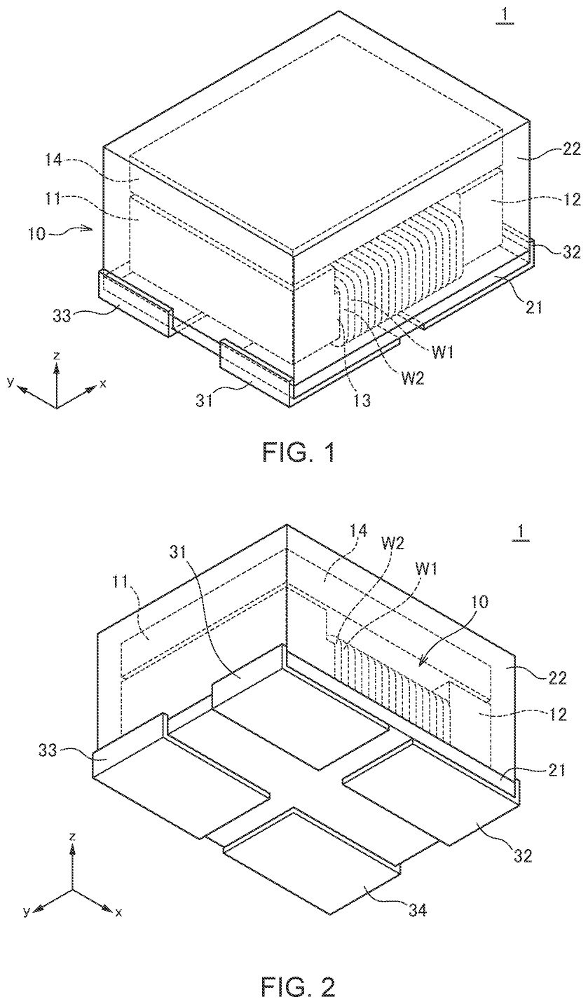

FIG. 1 is a schematic transparent perspective view illustrating the outer appearance of a coil component 1 according to a first embodiment of the present invention. FIG. 2 is a schematic transparent perspective view of the coil component 1 as viewed in a different angle from the angle of FIG. 1.

The coil component 1 according to the first embodiment is a common mode filter and includes, as illustrated in FIGS. 1 and 2, a flat plate-like base member 21, a magnetic core 10 mounted on the xy top surface of the base member 21, a plate-like core 14 fixed to the magnetic core 10, wires W1 and W2 wound around a winding core part 13 of the magnetic core 10, terminal electrodes 31 to 34 fixed to the base member 21, and a molding member 22 formed on the base member 21 so as to cover the magnetic core 10 and plate-like core 14. Both ends of wire W1 are connected respectively to the terminal electrodes 31 and 32, and both ends of the wire W2 are connected respectively to the terminal electrodes 33 and 34.

The magnetic core 10 has a U-like shape and includes a winding core part 13 whose axis extends in the x-direction, a leg part 11 provided at one axial end portion of the winding core part 13 and protruding in the +z-direction, and a leg part 12 provided at the other axial end portion of the winding core part 13 and protruding in the +z-direction. Unlike in a drum-shaped magnetic core, the leg parts 11 and 12 do not protrude in the −z direction. Namely, the leg parts 11 and 12 protrude not toward the base member 21 but only toward the side facing away from the base member 21. The reason is as follows. That is, a magnetic core like a drum-shaped magnetic core needs to ensure an area for forming the terminal electrodes 31 to 34, whereas the magnetic core 10 according to the present embodiment does not have such a need since the terminal electrodes 31 to 34 are formed on the base member 21. The magnetic core 10 is made of a magnetic material having a high permeability, such as Ni—Zn based ferrite.

Like the magnetic core 10, the plate-like core 14 is made of a magnetic material having a high permeability, such as Ni—Zn based ferrite and is fixed to the leg parts 11 and 12 by an adhesive or the like to form a closed loop magnetic path. The plate-like core 14 and magnetic core may not necessarily be made of the same magnetic material; however, when a material having a higher permeability than at least a material constituting the base member 21, inductance can be significantly increased.

The base member 21 is a plate-like member made of a material having a permeability lower than that of the magnetic core 10. Specifically, a composite material obtained by dispersing metal magnetic particles in a resin binder or a non-magnetic material, such as resin, may be used. As described later, the base member 21 reduces an eddy current loss and serves as a buffer.

The molding member 22 is a protective member that covers the magnetic core 10 and wires W1 and W2. The molding member 22 is not particularly limited in material and may be made of the same material as the base member 21 or a material having a permeability higher than that of the base member 21. When a material having a permeability higher than that of the base member 21 is used for the molding member 22, magnetic flux leaked to the outside can be reduced, and inductance can be increased. However, the magnetic core 10 may not necessarily be covered with the molding member 22 in the present invention, but may be exposed.

The terminal electrodes 31 to 34 may be a metal fitting made of a good conductor material such as copper, or may be obtained by directly baking silver paste or the like onto the base member 21. In the former case, the terminal electrodes 31 to 34 and the base member 21 can be fixed using an adhesive or the like. In the present embodiment, the terminal electrodes 31 to 34 have an L shape, but not limited to this, and it suffices that they are formed at least on the xy lower surface of the base member 21.

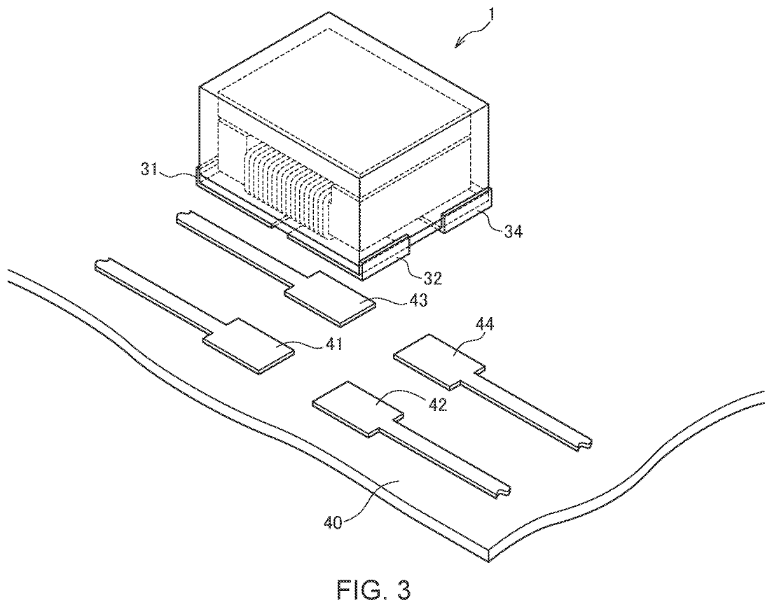

As illustrated in FIG. 3, the thus configured coil component 1 can be surface-mounted on a substrate 40 using a solder or the like such that land patterns 41 to 44 formed on the surface of the substrate 40 and the terminal electrodes 31 to 34 are electrically and mechanically connected respectively. In a state where the coil component 1 is mounted on the substrate 40, the coil axis of the coil component 1 is parallel to the substrate 40. Thus, the amount of magnetic flux to be applied to the terminal electrodes and land patterns is reduced as compared to when a coil component having a coil axis perpendicular to the substrate is used.

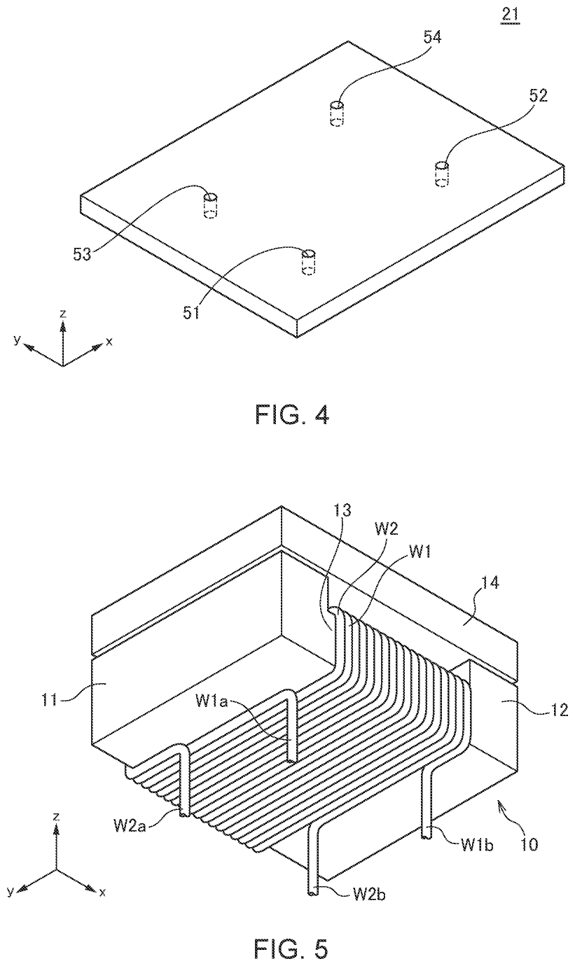

In the manufacturing process of the coil component 1, first the base member 21 illustrated in FIG. 4 is prepared. The base member 21 is a plate-like member whose main surface is the xy surface and whose thickness direction is the z-direction and has four through holes 51 to 54 penetrating therethrough in the z-direction. Then, as illustrated in FIG. 5, after the wires W1 and W2 are wound around the winding core part 13 of the magnetic core 10, the plate-like core 14 is fixed to the leg parts 11 and 12 of the magnetic core 10. Then, the magnetic core 10 is placed on the base member 21 such that one end W1a of the wire W1, the other end W1b of the wire W1, one end W2a of the wire W2, and the other end W2b of the wire W2 are inserted into the through holes 51 to 54, respectively, followed by bending of the tip ends of the wires W1 and W2 protruding from the through holes 51 to 54. Then, after the magnetic core 10 is covered with the molding member 22, the terminal electrodes 31 to 34 are formed on the base member 21, whereby the coil component 1 according to the present embodiment is completed.

The surfaces of the terminal electrodes 31 to 34 are each preferably covered with a plating film for enhancing wettability to a solder. Even when such a plating film is formed, the wires W1 and W2 are not exposed to plating solution during a formation process of the plating film since they are covered with the molding member 22 together with the magnetic core 10.

In the coil component 1 according to the present embodiment, the terminal electrodes 31 to 34 are not directly formed on the magnetic core 10, but they are formed on the base member 21 on which the magnetic core 10 is mounted, so that a magnetic field generated by current flowing in the wires W1 and W2 is less likely to reach the terminal electrodes 31 to 34. That is, as compared to a coil component using common drum-shaped core, the density of magnetic flux to be applied to the terminal electrodes 31 to 34 and land patterns 41 to 44 is lower, thus reducing an eddy current. This can reduce heat generation of the terminal electrodes 31 to 34 and land patterns 41 to 44. In addition, when resin or a composite material is used as the material of the base member 21, the base member 21 functions as a buffer, so that when the component 1 mounted on the substrate 40 is coated with a moisture-proof coating, it is possible to make the fragile magnetic core 10 made of ferrite or the like less likely to be broken due to the stress of the moisture-proof coating.

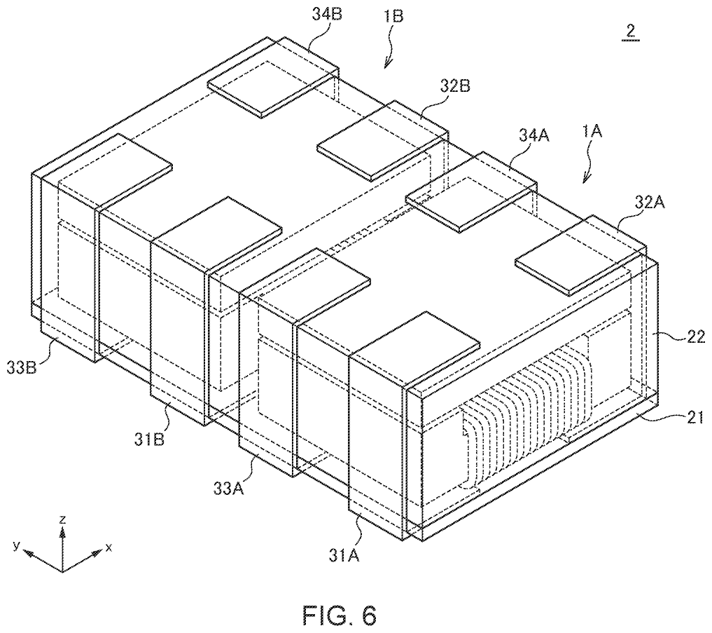

FIG. 6 is a schematic transparent perspective view illustrating the outer appearance of a coil component 2 according to a second embodiment of the present invention.

The coil component 2 illustrated in FIG. 6 includes first and second coil parts 1A and 1B each having basically the same structure as the coil component 1 according to the first embodiment and sharing the base member 21 and molding member 22. With this configuration, the coil component 2 can be used as an array product in which two common mode filters are integrated into one chip. This allows a configuration in which terminal electrodes 31A to 34A provided in the coil component 1A and terminal electrodes 31B to 34B provided in the coil component 1B are connected to a first differential signal line and a second differential signal line, respectively.

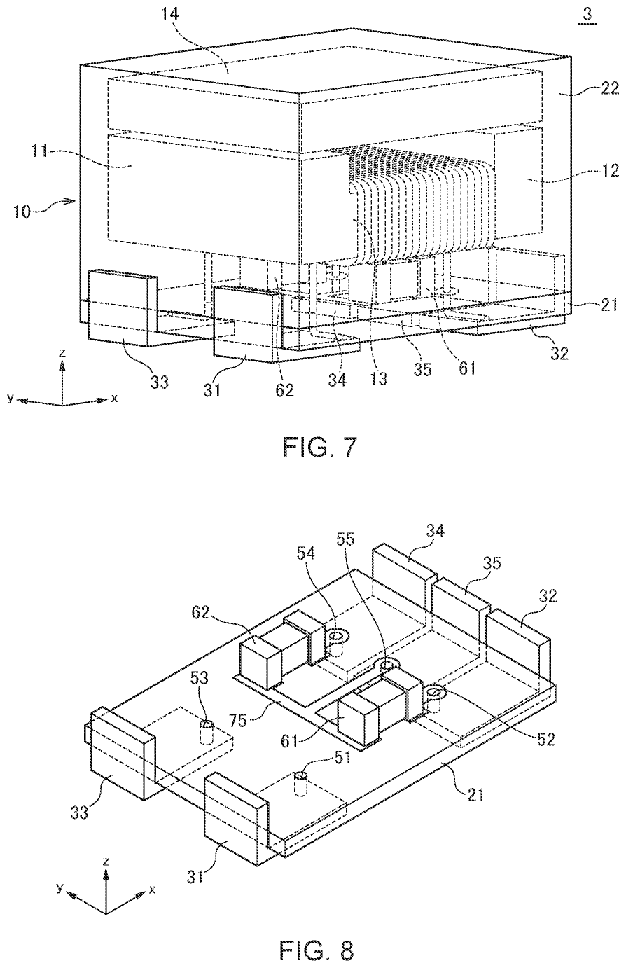

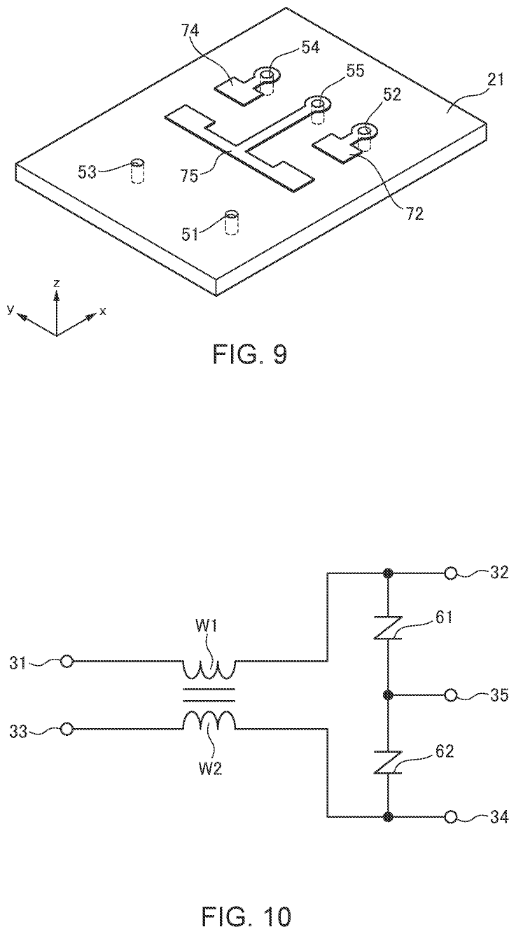

FIG. 7 is a schematic transparent perspective view illustrating the outer appearance of a coil component 3 according to a third embodiment of the present invention. FIG. 8 is a view illustrating a state where the magnetic core 10, plate-like core 14, and wires W1 and W2 are removed from the coil component 3. FIG. 9 is a view illustrating the structure of the base member 21.

As illustrated in FIGS. 7 to 9, the coil component 3 according to the third embodiment includes electronic components 61 and 62, such as a varistor, mounted on the surface of the base member 21. The electronic component 61 is inserted between connection patterns 72 and 75 formed on the surface of the base member 21, and the electronic component 62 is inserted between connection patterns 74 and 75 formed on the surface of the base member 21. The connection patterns 72, 74, and 75 are provided so as to overlap respectively through holes 52, 54, and 55 penetrating the base member 21. Thus, as illustrated in an equivalent circuit diagram of FIG. 10, the electronic component 61 is connected between the terminal electrodes 32 and 35, and the electronic component 62 is connected between the terminal electrodes 34 and 35, whereby the coil component 3 can be used as a more sophisticated module component.

It is apparent that the present invention is not limited to the above embodiments, but may be modified and changed without departing from the scope and spirit of the invention.

For example, in the above embodiments, the present invention is applied to the common mode filter, but not limited to this.

What is claimed is:

1. A coil component comprising:
a plate-like base member;
a magnetic core mounted on the base member;
a wire wound around the magnetic core such that an axis direction thereof is substantially parallel to the base member; and
a terminal electrode fixed to the base member and connected to an end portion of the wire,
wherein the base member is made of a material having a permeability lower than that of the magnetic core.

2. The coil component as claimed in claim 1,
wherein the base member has a through hole, and
wherein the end portion of the wire is connected to the terminal electrode through the through hole.

3. The coil component as claimed in claim 1, wherein the magnetic core has a U-like shape having a winding core part around which the wire is wound and first and second leg parts provided at axially opposite ends of the winding core part and protruding facing away from the base member.

4. The coil component as claimed in claim 3, further comprising a plate-like core fixed to the first and second leg parts and having a permeability higher than that of the base member.

5. The coil component as claimed in claim 1, further comprising a molding member formed on the base member so as to cover the magnetic core.

6. The coil component as claimed in claim 5, wherein the molding member is made of a material having a permeability higher than that of the base member.

7. The coil component as claimed in claim 1, wherein a plurality of the magnetic cores are mounted on the base member.

8. The coil component as claimed in claim 1, further comprising an electronic component mounted on the base member,
wherein the end portion of the wire and the terminal electrode are connected through the electronic component.

9. A coil component comprising:
a base member having first and second surfaces opposite to each other;
a magnetic core mounted on the first surface of the base member;
first and second terminal electrodes provided on the second surface of the base member; and
a wire wound around the magnetic core,
wherein the wire has one end connected to the first terminal electrode and other end connected to the second terminal electrode, and
wherein a permeability of the base member is lower than a permeability of the magnetic core.

10. The coil component as claimed in claim 9,
wherein the base member further has a side surface substantially perpendicular to the first and second surfaces, and
wherein a part of the first terminal electrode and a part of the second terminal electrode are provided on the side surface of the base member.

11. The coil component as claimed in claim 10, further comprising a molding member formed on the first surface of the base member so as to cover the magnetic core.

12. The coil component as claimed in claim 11, wherein another part of the first terminal electrode and another part of the second terminal electrode are provided on a side surface of the molding member.

13. The coil component as claimed in claim 12, wherein the side surface of the base member and the side surface of the molding member are coplanar with each other.

14. The coil component as claimed in claim 9,
wherein the base member has first and second through holes,
wherein the one end of the wire is connected to the first terminal electrode through the first through hole, and
wherein the other end of the wire is connected to the second terminal electrode through the second through hole.
